(19) United States
(12) Patent Application Publication
(10) Pub. No.: US 2021/0126490 A1
(43) Pub. Date: Apr. 29, 2021

(54) AQUARIUM WITH WIRELESS POWER SUPPLY FUNCTION

(71) Applicant: DS Power Co. Ltd., Hsinchu City (TW)

(72) Inventors: SHEN-JYE SHIEH, Hsinchu City (TW); CHING-YUAN HUANG, Hsinchu City (TW); CHIH-HSIUNG YU, Hsinchu City (TW); LI-HAN CHEN, Hsinchu City (TW); JU-CHUN LIU, Hsinchu City (TW); KAI-YI CHOU, Hsinchu City (TW)

(21) Appl. No.: 16/731,433

(22) Filed: Dec. 31, 2019

(30) Foreign Application Priority Data
Oct. 23, 2019 (TW) 108138214

(51) Int. Cl. H02J 50/10; A01K 63/04; A01K 63/06; A01K 63/00

(52) U.S. Cl. CPC H02J 50/10; A01K 63/006; A01K 63/065; A01K 63/045

(57) ABSTRACT

An aquarium with a wireless power supply function is disclosed. In the aquarium, a base frame is disposed under a water tank, a top box is disposed on the water tank, and the base frame includes a coil box and a coil holder. The coil holder is disposed on the coil box, and an outer diameter of the coil holder is smaller than an inner diameter of the coil box, to form a gap between the coil box and the coil holder to dispose a first coil around the coil box. The first coil can generate electromagnetic induction when being energized. The first coil surrounds an outer side of a bottom of the water tank, and a second coil is disposed around an inner periphery of the top box, so that the first coil can generate electric energy through electromagnetic induction and transfer power to multiple devices.

This application claims priority for Taiwan patent application no. 108138214 filed on Oct. 23, 2019, the content of which is incorporated by reference in its entirely.

### BACKGROUND OF THE INVENTION

### 1. Field of the Invention

The present invention relates to an aquarium, more particularly to an aquarium with a wireless power supply function.

### 2. Description of the Related Art

In order to use a conventional aquarium to raise aquarium fish or plant aquatic plants, it is necessary to install various life support devices such as a lighting device, a pumping motor, a filtering device, a temperature control device, and nitrifying bacteria culture materials, to maintain water quality and stable water temperature in the water tank, thereby extending the life of the aquarium fish in the water tank.

However, the numerous life support devices must be plugged with power sockets to receive power for operation, and it causes a problem that multiple wires are exposed to cause environmental disorder. Therefore, another conventional aquarium is provided with a wireless power supply pad disposed at a bottom thereof and configured to supply power to multiple life support devices above. The wireless power supply pad can solve the problem of excessive wires, but it also causes a problem that electromagnetic induction of a spiral-shaped coil in a too large water tank is too weak to transfer power to the electronic device on a top of the water tank and away from the spiral coil by a long distance.

Therefore, the present invention proposes an aquarium with a wireless power supply function, so as to effectively solve the above problems. The specific architecture and embodiments of the aquarium of the present invention will be described in detail in following paragraphs.

### SUMMARY OF THE INVENTION

An objective of the present invention is to provide an aquarium with a wireless power supply function, and in the aquarium, a first coil is disposed in a detachable coil holder, and when a base frame is combined with a water tank, the first coil can just enclose an outer side of a bottom the water tank, so as to solve the conventional problem that a spiral-shaped coil has poor electromagnetic induction when the electronic device is more away from the spiral-shaped coil.

Another objective of the present invention is to provide an aquarium with a wireless power supply function, and in the aquarium, a second coil is disposed in a top box and configured to generate electromagnetic induction with the first coil in the base frame, so as to strengthen electromagnetic induction effect and supply power to an electronic device in the top box, such as a lamp.

Another objective of the present invention is to provide an aquarium with a wireless power supply function, and in the aquarium, a water filter box is disposed in the top box, to facilitate a user to take out the water filter box for cleaning and replacing filter material.

Another objective of the present invention is to provide an aquarium with a wireless power supply function, and in the aquarium, a temperature control device such as a heater or a thermostat can be disposed in the coil box of the base frame and wirelessly supplied with power through the first coil, so as to solve the conventional problem that the temperature control device is exposed and there are too-many electric wires, and the coil can be used to supply power wirelessly to multiple devices at the same time.

In order to achieve aforementioned objectives, the present invention provides an aquarium with a wireless power supply function, and the aquarium includes a base frame, a water tank and a top box. The base frame includes a coil box and a coil holder. The coil holder is overlaid on the coil box, and an outer diameter of the coil holder is smaller than an inner diameter of the coil box, so as to form a gap between the coil box and the coil holder to dispose a first coil around the coil holder, and the first coil is configured to be energized to generate electromagnetic induction. The water tank is disposed on the coil holder, and the first coil is disposed around an outer side of a bottom of the water tank. The top box is disposed above the water tank, and configured to use a pumping motor to pump water from the water tank to the top box and then flow the water back to the water tank from a water outlet of the top box. The top box has a coil groove disposed therein to accommodate a second coil configured to generate electromagnetic induction with the first coil.

According to an embodiment of the present invention, the aquarium further includes at least one circuit device disposed in the coil box and comprising a circuit board connected to the first coil, and configured to provide functions of voltage stabilization, rectification and AC-DC conversion. Furthermore, the aquarium further includes a coil box cover disposed between the coil box and the coil holder, and configured to cover the circuit device in the coil box and prevent water leakage.

According to an embodiment of the present invention, the coil box has a first accommodation space configured to accommodate at least one of a heater and a thermostat. Furthermore, the at least one of the heater and the thermostat is wirelessly supplied with power through the electromagnetic induction generated by the first coil, or through commercial power by being connected to an electric wire.

According to an embodiment of the present invention, the coil box cover comprises an opening formed thereon and located above the first accommodation space, and an area of the opening is smaller than or equal to an area of the first accommodation space.

According to an embodiment of the present invention, the top box has a coil groove formed therein and configured to accommodate a second coil which generates electromagnetic induction with the first coil. In an embodiment, the coil groove is disposed along an inner wall of the top box.

According to an embodiment of the present invention, the top box has a third accommodation space configured to accommodate a lamp which is wirelessly supplied power through electromagnetic induction generated by the first coil or the second coil. Furthermore, the pumping motor is electrically connected to the second coil.

According to an embodiment of the present invention, the top box has a fourth accommodation space configured to accommodate a water filter box which uses filter material disposed therein to filter the water.

According to an embodiment of the present invention, the first coil is disposed around an outer periphery of the coil holder and configured to warm a bottom of the water tank by using heat generated after being energized.

According to an embodiment of the present invention, the aquarium further includes at least one electronic device disposed in the water tank and encapsulated by waterproof glue for waterproof effect, and the electronic device is supplied with power wirelessly through the first coil.

### BRIEF DESCRIPTION OF THE DRAWINGS

The structure, operating principle and effects of the present invention will be described in detail by way of various embodiments which are illustrated in the accompanying drawings.

FIG. 1 is a perspective view of an aquarium with a wireless power supply function, according to the present invention.

FIG. 2 is a perspective view of a base frame of an aquarium with a wireless power supply function, according to the present invention.

FIG. 3 is a side sectional view of a base frame of an aquarium with a wireless power supply function, according to the present invention.

FIG. 4 is an exploded view of a base frame of an aquarium with a wireless power supply function, according to the present invention.

FIG. 5 is a perspective view of a top box of an aquarium with a wireless power supply function, according to the present invention.

FIG. 6 is a side sectional view of a top box of an aquarium with a wireless power supply function, according to the present invention.

FIG. 7 is a side sectional view of a top box of an aquarium with a wireless power supply function, according to the present invention, when viewed from another angle.

FIG. 8 is an exploded view of a top box of an aquarium with a wireless power supply function, according to the present invention.

FIG. 9A and FIG. 9B are an exploded view and a side sectional view of another embodiment of an aquarium with a wireless power supply function, according to the present invention, respectively.

FIG. 10A and FIG. 10B are schematic views of an embodiment of an encapsulated waterproof electronic device and a schematic view of the encapsulated waterproof electronic device placed in a water tank, according to the present invention, respectively.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise”, “include” and “have”, and variations such as “comprises”, “comprising”, “includes”, “including”, “has” and “having” will be acknowledged to imply the inclusion of stated elements but not the exclusion of any other elements.

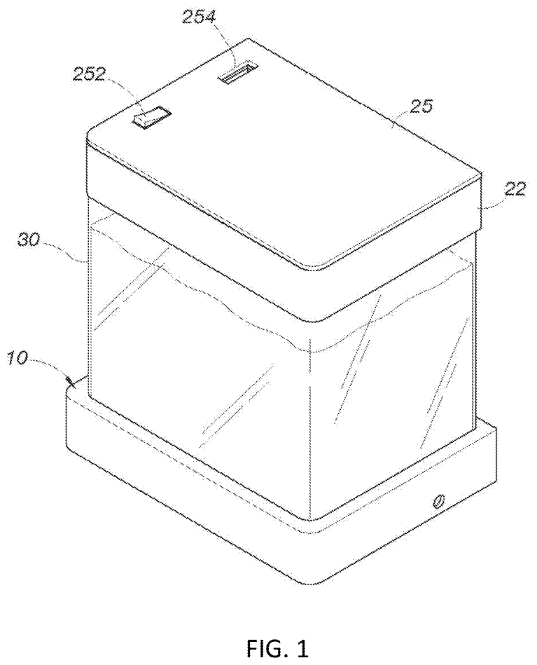

The present invention provides an aquarium with a wireless power supply function. Please refer to FIG. 1, which is a perspective view of an aquarium with a wireless power supply function, according to the present invention. As shown in FIG. 1, the aquarium comprises a water tank 30, a base frame 10, and a top box 22. The base frame 10 can be used to accommodate the water tank 30 and supply power wirelessly, and the top box 22 can be used to filter water in the water tank 30. The structure of the aquarium will be described in detail in following paragraphs.

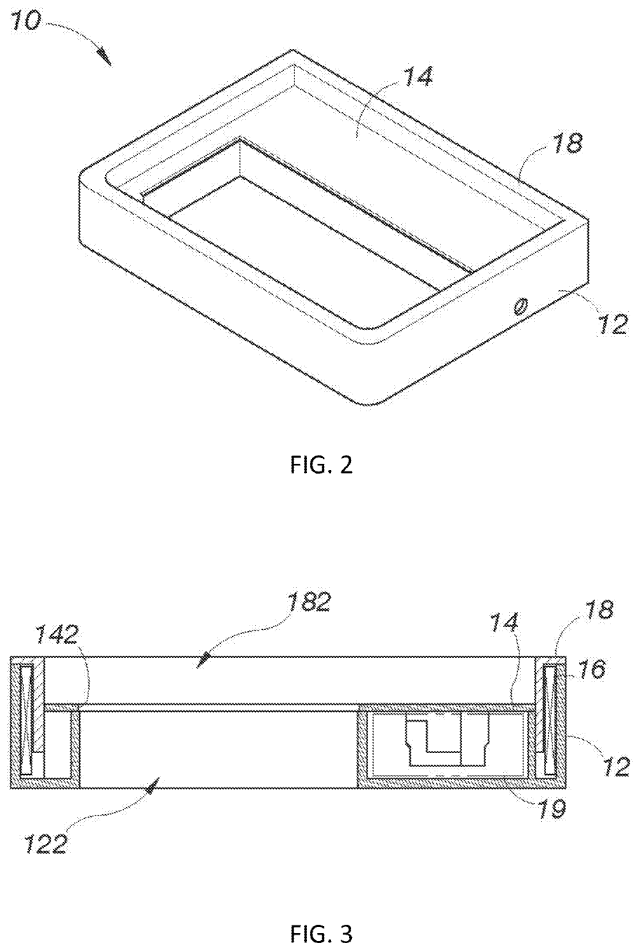

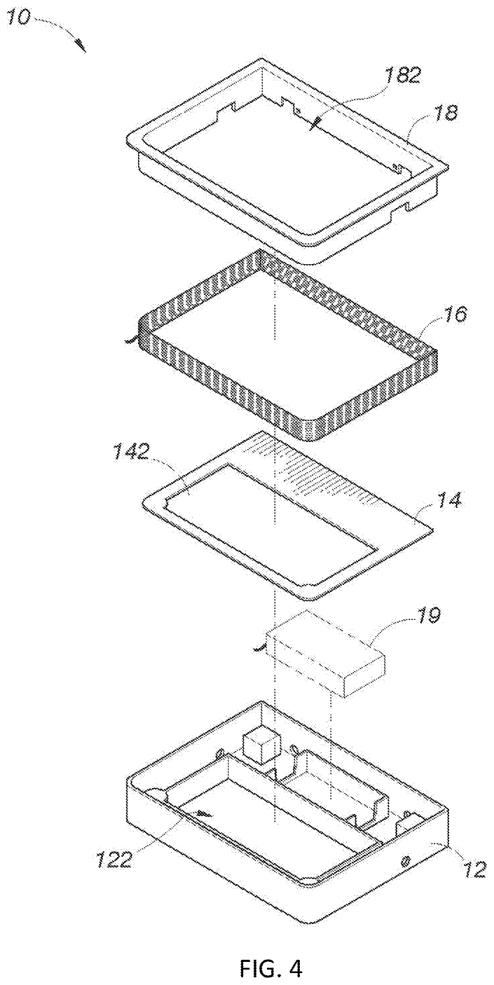

Please refer to FIGS. 2 to 4, which are a perspective view, a side sectional view and an exploded view of a base frame 10 of the aquarium of the present invention, respectively. As shown in FIGS. 2 to 4, the base frame 10 comprises a coil box 12, a coil box cover 14 and a coil holder 18. The coil box cover 14 is placed in the coil box 12, the coil holder 18 is disposed on the coil box cover 14. As shown in FIG. 3, a size of the coil box cover 14 is smaller than that of the coil holder 18, so as to prevent from affecting combination of the coil holder 18 and the coil box 12. The coil box 12 can be divided into two sections, at least one circuit device 19 is disposed in one of the two sections; for example, the at least one circuit device 19 can include a circuit board or a transformer configured to provide functions of voltage stabilization, rectification and AC-DC conversion. A first accommodation space 122 is formed in the other of the two sections to accommodate a heater, which is not shown in figures, or a thermostat, which is not shown in figures; or, the first accommodation space 122 can be used to accommodate both of the heater and the thermostat. The coil box cover 14 can cover the circuit device 19 to prevent water leakage; however, an opening 142 can be formed on the coil box cover 14 above the first accommodation space 122, and a shape, a size and an area of the opening 142 are similar to that of the first accommodation space 122, and the shape, the size and the area of the opening 142 is generally smaller than or equal to that of the first accommodation space 122, so that at least one of the heater and the thermostat can be exposed. The coil holder is hollow, and a second accommodation space 182 is formed in the hollow part to accommodate the water tank. Generally, the second accommodation space 182 is equivalent to an inner-groove-type water tank fixing groove. An outer diameter of the coil holder 18 is smaller than an inner diameter of the coil box 12, so that a gap can be formed between the coil box 12 and the coil holder 18 and a first coil 16 can be disposed around the coil box 12, as shown in FIG. 3. The first coil 16 is a ring-shaped coil with the same half diameter and not a spiral-shaped coil with a gradually-reduced half diameter, so that the first coil 16 can generate electromagnetic induction when being energized, thereby generating electric energy through magnetic force.

The water tank is placed in the second accommodation space 182 of the coil holder 18, and the heater and the thermostat can be wirelessly supplied with power through electromagnetic induction generated by the first coil 16, or supplied with power through commercial power by being connected to an electric wire, which is not shown in figures. After being powered, the heater and the thermostat can generate and conduct heat to the water tank through the first accommodation space 122 and the opening 142, thereby controlling the water temperature of the water tank.

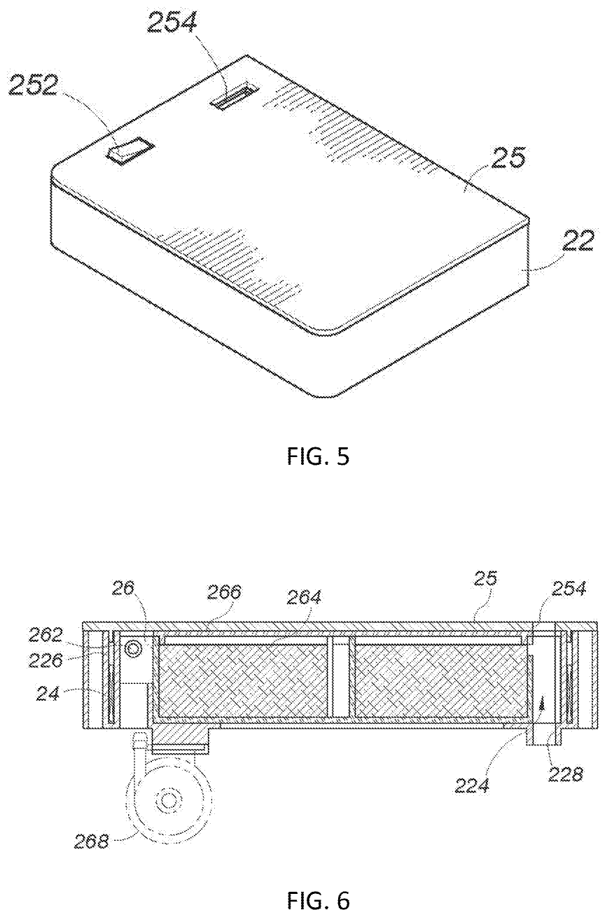

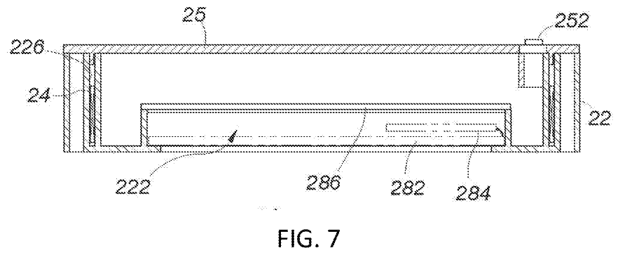

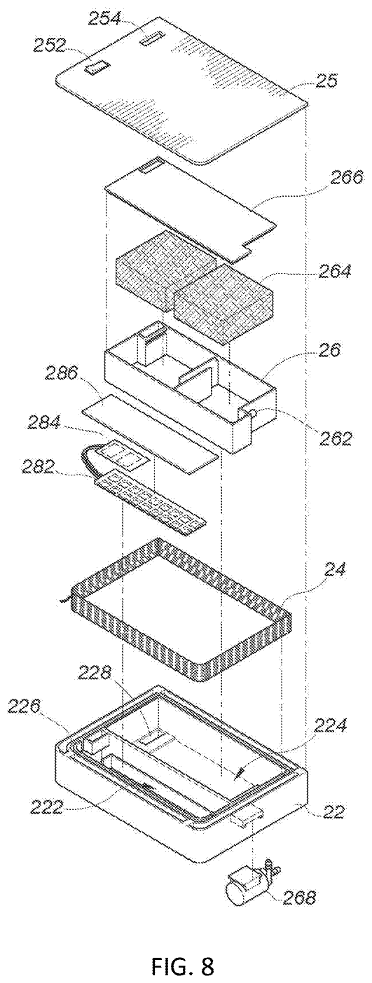

Please refer to FIGS. 5 and 8, which are a perspective view, two side sectional views viewed from two different angles, and an exploded view of the top box 22, respectively. As shown in FIGS. 5 and 8, the top box 22 is disposed above the water tank and uses a pumping motor 268 to pump water from the water tank to the top box 22, filter the water, and then flow the filtered water back to the water tank through a water outlet 228. The top box 22 can be divided into two sections comprising a third accommodation space 222 and a fourth accommodation space 224. The third accommodation space 222 can be used as a lamp box to place a lamp 282 such as a lamp tube, a bulb, or an LED. When the lamp 282 is implemented by the LED, the lamp 282 can comprise a circuit board 284 to control a light-emitting status, such as lighting status, color or flashing status, of the lamp 282. The fourth accommodation space 224 can be used to accommodate a water filter box 26 having a water inlet 262 formed on a side thereof and connected to the pumping motor 268, and a hole (not shown in figures) formed on other section and in communication with to the water outlet 228. The water filter box 26 can has single groove or multiple grooves dependent on the size of the water tank; in this embodiment, the water filter box 26 has two grooves, and at least one filter material 264 can be accommodated in the groove to filter the water upon the number of the grooves. When the water filter box 26 has two grooves, two filter materials 264 can be placed in the two grooves, respectively. In an embodiment, the filter material 264 can be a sponge and a nitrification stone, or activated carbon. When the pumping motor 268 pumps dirty water from the water tank, the dirty water can be flowed into the water filter box through the water inlet 26 and filtered by the filter material 264, and then flowed back to the water tank from the water outlet 228, so as to complete the water filtering circulation. Particularly, the water filter box 26 of the present invention is detachable and can be effortlessly taken out from the fourth accommodation space 224, so as to facilitate the user to clean the water filter box 26 or replace the filter material. The water filter box 26 can include a water filter box cover 266 disposed thereon.

The top box 22 has a coil groove 226 disposed therein and configured to accommodate a second coil 24 which can serve as an auxiliary coil to generate electromagnetic induction with the first coil of the base frame. The electric energy generated by the first coil can trigger the second coil 24 to generate magnetic field, so that the second coil 24 can generate electric energy through the magnetic field after being triggered. In an embodiment of the present invention, the coil groove 226 is disposed along an inner wall of the top box 22.

In the present invention, the second coil 24 is one of the primary mechanisms for receiving electric energy; each of the lamp 282, the circuit board 284 and the pumping motor 268 can have an independent coil, and the second coil 24 can also be electrically connected to all loads disposed in the top box 22, and the loads such as the lamp 282, the circuit board 284 and the pumping motor 268 can receive electric energy through the second coil 24 after being electrically connected to the second coil 24 through the circuit boards thereof.

In another embodiment, in a condition that the water tank is not high and the top box 22 is close to the base frame, the second coil 24 can be used or not. When no second coil 24 is used in the aquarium, the first coil can supply power to the electronic devices, such as the lamp 282, the circuit board 284 and the pumping motor 268, but such electronic devices must be provided with independent coils to induce with the first coil to receive electrical power from the first coil; otherwise, when the top box 22 comprises the second coil 24 disposed therein, the distances between the second coil 24 and the loads of the top box 22 are shorter, so the second coil 24 can supply power to the loads, and the second coil 24 can generate electromagnetic resonance with the first coil, so that the electric energy generated by the first coil can be transferred to the second coil 24. Furthermore, the second coil 24 can have an additional characteristic of serving as a relay coil when being driven by a resonance device (such as the first coil), so as to extend the inductive distance. Therefore, when the original coil is smaller and has poor inductive effect, the second coil 24 can be used as a relay coil to enhance induction effect for the load having a coil.

The top box cover 25 comprises a switch 252 disposed thereon and in contact with the circuit board 284, and configured to switch the lamp 282. Furthermore, when the lamp 282 is implemented by an LED, the circuit board 284 can control a light-emitting status, such as lighting status, color or flashing status, of the lamp 282, and the light-emitting status can be remotely operated by a remote controller or a smartphone. Similarly, when the thermostat or the heater in the base frame are provided with the remote operation functions, the thermostat and the heater can also be remotely controlled by a remote controller or a smartphone.

Please refer back to FIG. 1. The top box cover 25 can have a feeding hole 254 in communication with the water outlet 228 of the top box 22 through the water filter box 26. The top box 22 fully covers the water tank, but an opening of the feeding hole 254 is left to allow a feeder to put feed into the water tank through the water filter box 26 from the water outlet 228.

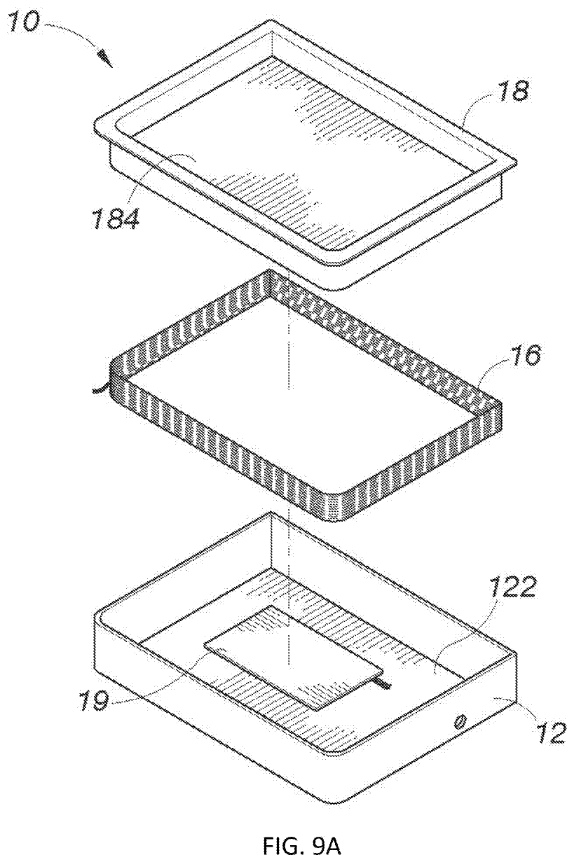

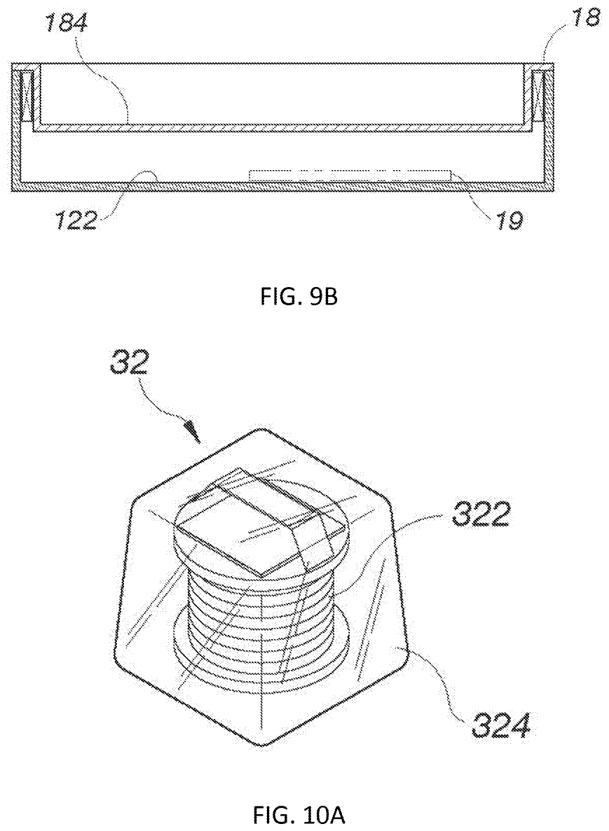

FIGS. 9A and 9B shows an exploded view and a side sectional view of another embodiment of the base frame 10 of the present invention. In this embodiment, the base frame 10 can be implemented without the coil box cover, and the base frame 10 includes the coil box 12, the first coil 16 and the coil holder 18 only, and the coil holder 18 is not hollow but is in a pallet shape with a bottom plate 184. The bottom plate 184 can carry the water tank. Furthermore, the coil box 12 has a single first accommodation space 122 and is not divided into two sections, so that the circuit device 19, such as the circuit board, can be directly placed in the first accommodation space 122 and also electrically connected to the first coil 16.

The first coil 16 is still disposed in the space between the coil box 12 and the coil holder 18. Particularly, as shown in FIG. 9B, since the first coil 16 is disposed around the outer periphery of the coil holder 18, after the water tank is placed in the coil holder 18 and the first coil 16 is energized, the heat conducted from the first coil 16 can warm the bottom of the water tank; furthermore, the water tank can be added with a heater or a thermostat upon required water temperature, or it is enough to directly use the heat of the first coil 16 for preserving heat and warming the water tank.

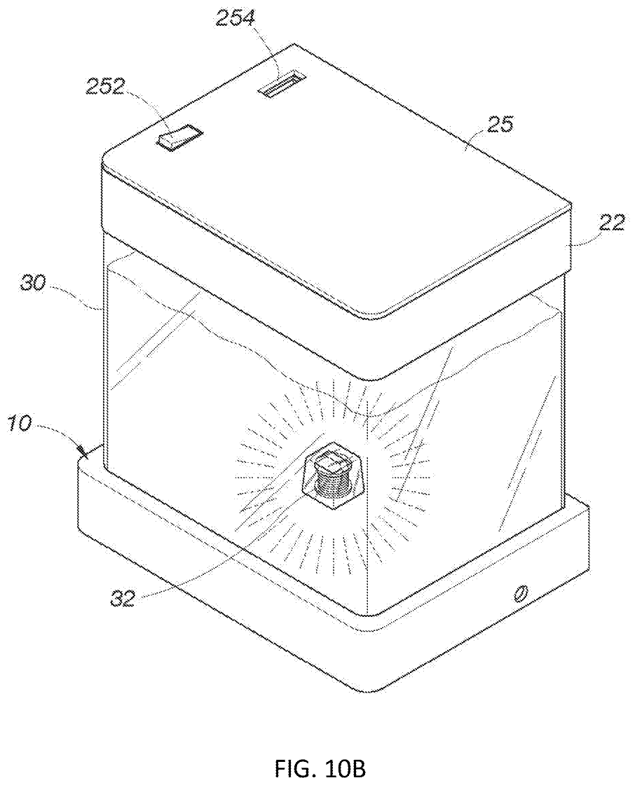

FIG. 10A and FIG. 10B are schematic views of an embodiment of an encapsulated waterproof electronic device and a schematic view of the encapsulated waterproof electronic device placed in a water tank, respectively. As shown in FIG. 10A, in the present invention, the electronic device 322 can be encapsulated by waterproof glue 324, to provide a waterproof effect. In an embodiment, the electronic device 322 can be a bulb, an LED, or a motor, and the waterproof glue 324 can be plastic, acrylate, other waterproof material, or plastic or non-plastic material. The electronic device 322 and the circuit board can be encapsulated together, and the encapsulated waterproof electronic device 32 can be placed in the water tank 30, as shown in FIG. 10B, and wirelessly supplied with power through the first coil of the base frame 10, so that the encapsulated waterproof electronic device 32 can be driven to operate.

According to above-mentioned contents, the aquarium with the wireless power supply function is provided in the present invention, the coil is disposed on the detachable coil holder, the heater can be disposed in the coil box, the coil can generate electric energy through electromagnetic induction and transfer electric energy to multiple devices, and another coil can be added in the top box to strengthen electromagnetic induction, so that the aquarium of the present invention can have the temperature control function and solve the conventional problem that the heater is exposed and there are too many electric wires. Furthermore, the water filter box can be disposed in the top box independently, so that the water filter box can be easily dismounted for cleaning or replacing a new one, and it is also more convenient to replace new filter material. The aquarium of the present invention is helpful for a feeder to clean the aquarium conveniently, and the appearance of the aquarium is regular without excess wire, and the feeder can control the lamp, the thermostat and electronic device through the smartphone or the remote controller, so as to provide beautiful performance, practicability and convenience.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An aquarium with a wireless power supply function, comprising:
a base frame comprising a coil box and a coil holder, wherein the coil holder is overlaid on the coil box, and an outer diameter of the coil holder is smaller than an inner diameter of the coil box, so as to form a gap between the coil box and the coil holder to dispose a first coil around the coil holder, and the first coil is configured to be energized to generate electromagnetic induction;
a water tank disposed on the coil holder, wherein the first coil is disposed around an outer side of a bottom of the water tank; and
a top box disposed above the water tank, and configured to use a pumping motor to pump water from the water tank to the top box and then flow the water back to the water tank from a water outlet of the top box, wherein the top box has a coil groove disposed therein to accommodate a second coil configured to generate electromagnetic induction with the first coil.

2. The aquarium according to claim 1, further comprising at least one circuit device disposed in the coil box and comprising a circuit board connected to the first coil, and configured to provide functions of voltage stabilization, rectification and AC-DC conversion.

3. The aquarium according to claim 2, further comprising a coil box cover disposed between the coil box and the coil holder, and configured to cover the circuit device in the coil box and prevent water leakage.

4. The aquarium according to claim 3, wherein the coil box has a first accommodation space configured to accommodate at least one of a heater and a thermostat.

5. The aquarium according to claim 4, wherein the coil box cover comprises an opening formed thereon and located above the first accommodation space, and having an area smaller than or equal to an area of the first accommodation space.

6. The aquarium according to claim 4, wherein the at least one of the heater and the thermostat is wirelessly supplied with power through the electromagnetic induction generated by the first coil, or through commercial power by being connected to an electric wire.

7. The aquarium according to claim 1, wherein the top box has a third accommodation space configured to accommodate a lamp which is wirelessly supplied with power through electromagnetic induction generated by the first coil or the second coil.

8. The aquarium according to claim 1, wherein the top box has a fourth accommodation space configured to accommodate a water filter box which uses filter material disposed therein to filter the water.

9. The aquarium according to claim 1, wherein the coil groove is disposed along an inner wall of the top box.

10. The aquarium according to claim 1, wherein the first coil is disposed around an outer periphery of the coil holder and configured to warm the bottom of the water tank by using heat generated after being energized.

11. The aquarium according to claim 1, wherein the pumping motor is electrically connected to the second coil.

12. The aquarium according to claim 1, further comprising at least one electronic device disposed in the water tank and encapsulated by waterproof glue for waterproof effect, wherein the at least one electronic device is wirelessly supplied with power through the first coil.
